(19) United States
(12) Patent Application Publication
(10) Pub. No.: US 2024/0427140 A1
(43) Pub. Date: Dec. 26, 2024

(54) METHOD AND DEVICE OF DESIGNING OPTICAL SYSTEM

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Rui ZHU, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/822,248

(22) Filed: Sep. 1, 2024

Related U.S. Application Data
(63) Continuation of application No. PCT/CN2022/143122, filed on Dec. 29, 2022.

(30) Foreign Application Priority Data
Mar. 24, 2022 (CN) 202210296576.1

(51) Int. Cl. G02B 27/00; G02B 1/00

(52) U.S. Cl. CPC G02B 27/0012; G02B 1/002

(57) ABSTRACT

A method and a device of designing an optical system, and a storage medium are provided. The method includes: S1. determining an initial structure parameter of the optical system according to a design requirement; S2. optimizing the initial structure parameter according to the ray tracing method, and obtaining a theoretical structure parameter; S3. performing a discretization on a phase of a metalens of the theoretical structure parameter and obtaining a discrete phase; S4. performing an optical field propagation simulation according to the discrete phase, and obtaining an imaging performance index; S5. if the image performance index meets the design requirement, obtaining a target structure parameter; if the image performance index doesn't meet the design requirement, re-optimizing the image performance index and obtaining the target structure parameter.

### CROSS-REFERENCE TO RELATED APPLICATION

This application is a continuation of International Patent Application of PCT application serial No. PCT/CN2022/143122, filed on Dec. 29, 2022, which claims the benefit of priority from China Application No. 202210296576.1, filed on Mar. 24, 2022. The entirety of each of the above mentioned patent applications is hereby incorporated by reference herein and made a part of this specification.

### TECHNICAL FIELD

The present disclosure relates to the field of an optical system, in particular to a method and a device of designing an optical system.

### BACKGROUND

The metalens is an application of the metasurface, which can modulate the amplitude, phase and polarization of the incident light by the nanostructures set on it. With the development of metalens technology, the optical system combined with the metalens and the traditional refractive lens (also called as hybrid optical system of metalens and refractive lens) is more and more widely used.

However, the nanostructures are arranged in an array on the surface of the metalens, so the phase distribution of the metalens is more complicated than traditional lenses, and the traditional method of designing an optical system can't be applied to the optical system with the metalens and the traditional refractive lens.

### SUMMARY

In order to solve the problem that the traditional method of designing an optical system can't be applied to the optical system with the metalens and the traditional refractive lens in prior art, a method and a device of designing an optical system are provided.

In the first aspect of the present disclosure, a method of designing an optical system is provided. The method includes:
S1. determining an initial structure parameter of the optical system according to a design requirement;
S2. optimizing the initial structure parameter according to the ray tracing method, and obtaining a theoretical structure parameter;
S3. performing a discretization on a phase of a metalens of the theoretical structure parameter and obtaining a discrete phase;
S4. performing an optical field propagation simulation according to the discrete phase, and obtaining an imaging performance index;
S5. if the image performance index meets the design requirement, obtaining a target structure parameter;
if the image performance index doesn't meet the design requirement, re-optimizing the image performance index and obtaining the target structure parameter.

Optionally, the method includes: S201. initializing the initial structure parameter;
S202. initializing a parameter of the ray tracing method;
S203. performing the ray tracing method on a nₜₕ ray at a wₜₕ wavelength and of mₜₕ field of view for the W working wavelengths, M fields of view and N rays at each wavelength;
wherein, w=1, . . . , W; m=1, . . . , M; n=1, . . . , N;
S204. calculating a radius of encircled energy, so as to calculate the value of a target function.

Optionally, “optimizing to the initial structure parameter according to the ray tracing method” includes: minimizing a value of a target function; where the target function satisfies:

$$Tar = {\sum }_{i = 1} {c}_{i} {R}_{EE} ( {FOV}_{I} ) ;$$

where Tar is the target function, cᵢ is a weight factor in each field of view, REE (FOVi) is the radius of encircled energy

Optionally, S3 includes:
S301. selecting a plurality of nanostructures in a nanostructure database according to the theoretical structure parameter;
where the theoretical structure parameter includes a plurality of phases of the nanostructures on the metalens at different wavelengths.

Optionally, S3 includes:
S401. interpolating a plurality of discrete phases of a plurality nanostructures according to sizes and arrangements of a plurality of unit cells, and a refractive lens is equivalent to a planar phase;
S402. for W working wavelengths and M fields of view, performing an optical propagation simulation on optical field at the wₜₕ field of view to a focal plane;
S403. obtaining the image performance index according to the results of the optical propagation simulation.

Optionally, S403 includes:
S4031. obtaining a plurality of point spread functions at overall fields of view at the focal plane of the optical system;
S4032. obtaining another image performance index according to the plurality of point spread functions.

Optionally, S5 includes: when the image performance index doesn't meet the design requirement, repeating steps from the S2 to S4, till obtaining the image performance index met the design requirement.

Optionally, “optimizing the initial structure parameter” of S2 is based on the generalized refraction law.

Optionally, where the generalized refraction law includes: the refraction law and the nanostructure refraction formula; the refraction law is as follows:

$${n}_{i} sin {θ}_{i} = {n}_{r} sin {θ}_{r}$$

where, nᵢ is a refractive index of an incident medium, and nᵣ is a refractive index of a refractive medium respectively; θᵢ is an incident angle, and θᵣ is a refractive angle;
where the nanostructure refraction formula is as follows:

$${n}_{r} sin {θ}_{r} - {n}_{i} sin {θ}_{i} = \frac{{λ}_{0}}{2 π} \frac{d φ ( r )}{dr} ;$$

where nᵢ is a refractive index of an incident medium, and nᵣ is a refractive index of a refractive medium respectively; θᵢ is an incident angle, and θᵣ is a refractive angle; λ is a wavelength of light in the vacuum; r is a distance between the center of a metalens and a center of any nanostructure;

$$\frac{d φ ( r )}{dr}$$

is a phase gradient along the radial direction of the metalens.

Optionally, the method includes selecting a nanostructure with a phase that is closest to a practical phase by an optimization algorithm.

Optionally, the method further includes: S6. returning to S1 to re-select the initial structure parameters and repeat from S1 to S5 until the target structure parameter meets the design requirement.

Optionally, the design requirements include: a working waveband, a field of view, a focal length, a transmittance, a modulation transfer function and a total track length.

Optionally, the initial structure parameter includes a material, a number of a metalens and refractive lens, a phase of the metalens, a distance between the metalens and the refractive lens; a curvature of the refractive lens and an aspherical coefficient of the refractive lens.

Optionally, the calculation of the target function of the S204, the variables include: a phase of metalens, a distance between the metalens and a refractive lens, a curvature of the refractive lens, and an aspherical coefficient of the refractive lens.

Optionally, the calculation of the target function of the S204, the target function includes a size of a spot on the focal plane of the optical system.

In a second aspect of the present disclosure, a device of designing an optical is provided. The device includes: the device is applied to the method of designing the optical system and the device includes:
an inputting module, the inputting module is configured to input an initial structure parameter of the optical system;
a first optimization module, the optimization module is configured to perform optimization on the initial structure parameter according to the ray tracing method theory, so as to obtain a theoretical structure parameter;
a discretization module, the discretization module is configured to perform the discretization on a phase of a metalens of the theoretical structure parameter, so as to obtain a discrete phase;
a simulation module, the simulation module is configured to perform an optical field propagation simulation according to the discrete phase, so as to obtain an imaging performance index;
a second optimization module, the second optimization module is configured to obtain a target structure parameter, if the image performance index meets the design requirement;
and the second optimization module is configured to re-optimize the image performance index and obtain the target structure parameter, if the image performance index doesn't meet the design requirement.

Optionally, where the first optimization module includes:
a first initialization module, the first initialization module is configured to initialize the initial structure parameter;
a second initialization module, the second initialization module is configured to initialize a ray tracing method parameter;
a ray tracing module, performing the ray tracing method on a nₜₕ ray at a wₜₕ wavelength, mₜₕ field of view for the W working wavelengths, M fields of view and N rays at each wavelength; where, w=1, . . . , W; m=1, . . . , M; n=1, . . . , N;
a target function calculation module, the target function calculation module is configured to calculate a radius of encircled energy, so as to calculate the value of a target function.

Optionally, the discretization module includes:
a selecting module, the selection module is configured to select a plurality of nanostructures in a nanostructure database according to phases corresponding to the nanostructures at different wavelengths.

Optionally, the simulation module includes: an equivalent module, the equivalent module is configured to interpolate a plurality of discrete phases of a plurality of nanostructures according to sizes and arrangements of a plurality of unit cells, and to be equivalent a refractive lens as a planar phase;
a simulation calculation module, the simulation calculation module is configured to perform an optical propagation simulation on the wₜₕ field of view as the optical field propagating to a focal plane of the optical system for W working wavelengths and M fields of view, and obtain the image performance index according to the results of the simulation.

In a third aspect, an electronic device is provided, comprising: a bus, a processor, a transceiver, a bus interface, a memory, a user interface and a computer program;
where the computer program is stored in the memory and executable on the processor; the transceiver, the memory and the processor are connected through the bus; the computer program is executed by the processor, so as to implement the method.

In a fourth aspect of the present disclosure, a non-transitory computer-readable storage medium is provided. A computer program is stored in the storage medium. The computer program is executed by a processor, so as to implement the method of the first aspect of the present disclosure.

The method and device of designing the optical system provided by the embodiment of the present application has the effect as follows:
The method of designing the optical system optimizes the initial structure parameter based on the ray tracing method, in particular to optimize the metalens by the nanostructure refraction law, so as to obtain the theoretical structure parameter. And the theoretical structure parameter is discretization, so as to obtain the discrete phase to make the phase of the nanostructures of the metalens in the optical system closer to the phase of the metalens in practical production. Finally, the problem that the ray tracing method can't be applied to the discrete phase is overcame by using the optical propagation simulation, and the target structure parameter for production is obtained by the optimization of the distance phase.

### BRIEF DESCRIPTION OF THE DRAWINGS

In order to explain embodiments of the present disclosure or the prior art more clearly, drawings used in the description of the embodiments or the prior art will be briefly explained below. Obviously, the following drawings are merely for exemplary and explanatory purposes. It is understood by those skilled in the art that without paying any creative efforts, other drawings are available based on the following drawings.

FIG. 1 shows an optional flow chart of a method of designing an optical system according to an embodiment of the present application.

FIG. 2 shows a phase gradient along the radial direction of the metalens provided by the embodiment of the present application.

FIG. 3 shows a phase gradient along the radial direction of the metalens provided by the embodiment of the present application.

FIG. 4 shows a schematic diagram of the optimization of initial structure parameters based on the ray tracing method in the method of designing an optical system according to an embodiment of the present application.

FIG. 5 shows a schematic diagram of the discretization of the theoretical structure parameters in the method of designing an optical system according to an embodiment of the present application.

FIG. 6 shows a schematic diagram of the optical field propagation simulation based on the discrete phase in a method of designing an optical system according to an embodiment of the present application.

FIG. 7 shows a schematic diagram of the image performance index based on the simulation results in a method of designing an optical system according to an embodiment of the present application.

FIG. 8 shows the relationship between the diameter, wavelength and phase modulation of nanostructures in a method of designing an optical system according to an embodiment of the present application.

FIG. 9 shows the relationship between the diameter, wavelength and phase modulation of nanostructures in a method of designing an optical system according to an embodiment of the present application.

FIG. 10 shows a curve graph of the refractive index of germanium crystals at a wavelength from 8 to 12 μm.

FIG. 11 shows an optional theoretical structure of the optical system provided by the present application.

FIG. 12 shows a practical phase and a theoretical phase of ML₁ at the wavelength of 8 μm.

FIG. 13 shows a practical phase and a theoretical phase of ML₁ at the wavelength of 10 μm.

FIG. 14 shows a practical phase and a theoretical phase of ML₁ at the wavelength of 12 μm.

FIG. 15 shows a practical phase and a theoretical phase of ML₂ at the wavelength of 8 μm.

FIG. 16 shows a practical phase and a theoretical phase of ML₂ at the wavelength of 10 μm.

FIG. 17 shows a practical phase and a theoretical phase of ML₂ at the wavelength of 12 μm.

FIG. 18 shows a spot spread function an optional optical system at a 0 field of view.

FIG. 19 shows a spot spread function an optional optical system at a 0.5 field of view.

FIG. 20 shows a spot spread function an optional optical system at a 1.0 field of view.

FIG. 21 shows a modulation transfer function of all fields of view in an optional optical system provided by the embodiment of the present application.

FIG. 22 shows a modulation transfer function of all fields of view in an optional optical system provided by the embodiment of the present application.

FIG. 23 shows a schematic diagram of the device of designing an optical system provided by the embodiment of the present application.

FIG. 24 shows a schematic diagram of the first optimization module provided by the embodiment of the present application.

FIG. 25 shows a schematic diagram of the discretization module provided by the embodiment of the present application.

FIG. 26 shows a schematic diagram of the simulation module provided by the embodiment of the present application.

FIG. 27 shows a schematic diagram of the electronic device provided by the embodiment of the present application.

### DETAILED DESCRIPTION OF DISCLOSURED EMBODIMENTS

In the description of the embodiments of the present application, it should be known to those skilled in the art to which it belongs that the embodiments of the present application can be realized as a method, a device, and a computer-readable storage medium. Accordingly, the embodiments of the present application may be specifically realized in the following forms: complete hardware, complete software (including the firmware, resident software, microcode, etc.), and a combination of hardware and software. In addition, the embodiments of the present application may also be realized in the form of a computer program product in one or more computer-readable storage media that contains computer program code.

The computer-readable storage medium described above may employ any combination of one or more computer-readable storage mediums. Computer-readable storage media include: electrical, magnetic, optical, electromagnetic, infrared, semiconductor systems, devices, or any combination thereof. More specific examples of computer-readable storage media include: portable computer disks, hard drives, random access memory (RAM), read-only memory (ROM), erasable programmable read-only memory (EPROM), flash memory (Flash Memory), optical fiber, compact disc read-only memory (CD-ROM), optical storage devices, magnetic storage devices, or any combination of the above. In embodiments of the present application, the computer-readable storage medium may be any tangible medium containing or storing a program that may be used by or in combination with an instruction execution system, apparatus, device.

The computer program code contained in the computer-readable storage medium of the above computer may be transmitted with any appropriate medium, including: the wireless, wire, optical cable, RF (Radio Frequency) or any appropriate combination of the above.

Computer program code for performing the operations of embodiments of the present application may be written in assembly instructions, instruction set architecture (ISA) instructions, machine instructions, machine-related instructions, microcode, firmware instructions, state setup data, integrated circuit configuration data, or in one or more programming languages, or combinations thereof, the programming languages including object-oriented programming languages, e.g., Java, Smalltalk, C++, and also conventional procedural programming languages, e.g., C or the like. The computer program code may be executed entirely on the user's computer, partially on the user's computer, as a stand-alone software package, partially on the user's computer and partially on a remote computer, and entirely on a remote computer or server. In the case of a remote computer, the remote computer may be connected to the user's computer or to an external computer through any kind of network, including a local area network (LAN) or a wide area network (WAN).

The embodiment of the present application describes the methods, devices, and electronic devices provided by a flow chart and/or a block diagram.

It should be understood that each box of the flowchart and/or block diagram, and combinations of boxes in the flowchart and/or block diagram, may be implemented by computer-readable program instructions. These computer-readable program instructions may be provided to a processor of a general-purpose computer, a special-purpose computer, or other programmable data-processing device, thereby producing a machine in which these computer-readable program instructions are executed by the computer or other programmable data-processing device, producing a device that implements the functions/operations specified by the boxes in the flowchart and/or the block diagram.

It is also possible to store these computer-readable program instructions in a computer-readable storage medium that enables the computer or other programmable data processing device to operate in a particular manner. In this way, the instructions stored in the computer-readable storage medium produce an instruction device product that includes instructions to implement the functions/operations specified by the boxes in the flowchart and/or the block diagram.

It is also possible to load computer-readable program instructions onto a computer, other programmable data processing device or another device such that a series of operational steps are performed on the computer, other programmable data processing device or other device to produce a computer-implemented process such that the instructions performed on the computer or other programmable data processing device provide for the realization of the boxes in the flowchart and/or the block diagrams process that specifies a function/operation.

In the related techniques, there is a method of designing the optical system, which analyzes the phase of a single refractive lens and a metalens coupled with it, and obtains the theoretical structure of the single refractive lens and single metalens. On the one hand, although this paper obtained the theoretical structure of the single refractive lens and the single metalens, when the number of lenses increases due to the phase mutation brought by the nanostructure on the metalens, the imaging effect will change greatly. Therefore, the method doesn't apply to the optical system with the refractive lens and the metalens and the number of lenses larger than two pieces. On the other hand, due to the error in the processing of the nanostructures of the metalens, the practical imaging effect is different from the imaging of the theoretical structure, which can not meet the design requirements.

Therefore, there is an urgent need for an optical system design method that can be applied to the optical system with multiple refractive lenses and metalenses, and can overcome the influence of nanostructure processing errors on imaging effect.

Embodiments of the present application are described below in conjunction with the accompanying drawings of embodiments of the present application.

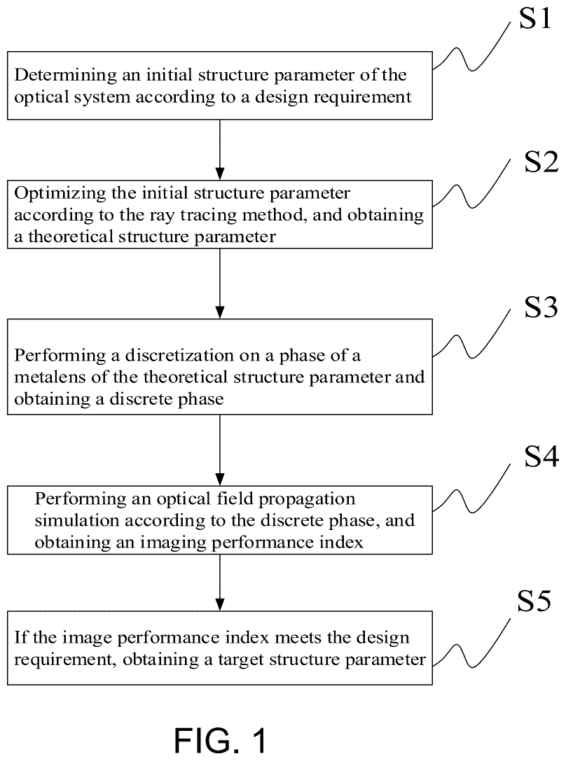

FIG. 1 shows a method of designing the optical system. As shown in FIG. 1, the method at least includes from S1 to S4 as follows:
S1. determining an initial structure parameter of the optical system according to a design requirement.

The design requirements include: a working waveband, a field of view, a focal length, a transmittance, an modulation transfer function and a total track length. The initial structure parameter includes a material, a number of a metalens and refractive lens, a phase of the metalens, a distance between the metalens and the refractive lens; a curvature of the refractive lens and an aspherical coefficient of the refractive lens. Generally, the material of the refractive lens and the metalens is determined by the working waveband of the optical system and the transmittance. For example, the material of the refractive lens is determined by the working waveband, and the substrate and nanostructure of metalens are made of materials with high transmittance in the working waveband selected in the nanostructure database. For example, the transmittance of the material of refractive lens and metalens for the working waveband is greater than or equal to 10%; or the transmittance of the material of refractive lens and metalens for the working waveband is greater than or equal to 20%; or the transmittance of the material of refractive lens and metalens for the working waveband is greater than or equal to 30%; or the transmittance of the material of refractive lens and metalens for the working waveband is greater than or equal to 40%; or the transmittance of the material of refractive lens and metalens for the working waveband is greater than or equal to 50%; or the transmittance of the material of refractive lens and metalens for the working waveband is greater than or equal to 60%; or the transmittance of the material of refractive lens and metalens for the working waveband is greater than or equal to 70%; or the transmittance of the material of refractive lens and metalens for the working waveband is greater than or equal to 80%; or the transmittance of the material of refractive lens and metalens for the working waveband is greater than or equal to 90%; or the transmittance of the material of refractive lens and metalens for the working waveband is greater than or equal to 95%. For example, the extinction coefficient of the material of the refractive lens and the metalens in the working waveband is less than or equal to 0.1. Finally, the number of pieces of the metalens and the refractive lens used in the initial structure is determined.

Specifically, the basic principle of determining the initial structure parameters is to change from simple to complex, reduce the number of pieces and reduce the total length of the system.

More specifically, the design principle is from simple to complex. For example, the initial structure selection starts from 1 P/G+1 ML, to 1 P/G+1 ML or 2 P/G+1 ML, and then to 1 P/G+2 ML or 2 P/G+1 ML, the complexity of the structure increases gradually. Where P/G refers to the plastic or glass lens, ML refers to the metalens. The principle of piece reduction means that the optical system that meets the design requirements by using the traditional refractive lens requires the lenses with the first number, and the first number is an integer that is greater than or equal to 3; when the metalens is combined with the traditional lens, the number of the total piece of the optical system is the second number, and the second number is less than the first number. The principle of TTL reduction means that the optical system meets the design requirements is the first length by using the traditional lenses, when the metalens is combined with the traditional lens, the TTL of the optical system is the second length, and the second length is less than the first length.

S2. Optimizing the initial structure parameter according to the ray tracing method, and obtaining a theoretical structure parameter.

The ray tracing method means tracing the propagation path a representative ray, so as to describe the behavior changes of the ray passes through the optical elements, and accurately describe the performance of the optical system. In some embodiments of the present application, in the calculation of the target function of the S204, the variables include: a phase of metalens, a distance between the metalens and a refractive lens, a curvature of the refractive lens, and an aspherical coefficient of the refractive lens. In one embodiment, the method includes taking the size of a spot on the focal plane of the optical system as the target function to perform the optimization. The method includes: if the optimization results diverge, selecting the initial optimization points for optimization, and if the optimization results converge, a phase of metalens, a distance between the metalens and a refractive lens, a curvature of the refractive lens, and an aspherical coefficient of the refractive lens are taking as the variables.

Optionally, during the optimization, the method may include: performing the ray tracing method based on the initial structure parameter where the target function uses the size of the radius of encircled energy in the field of view on the focal plane. And the encircled energy is defined to be a radius of the circle containing the focus of at least 90% of the ray trace. Each field of view can be set with corresponding weight coefficient.

The step of “optimizing to the initial structure parameter according to the ray tracing method” includes: minimizing a value of a target function; where the target function satisfies:

$$Tar = {\sum }_{i = 1} {c}_{i} {R}_{EE} ( {FOV}_{I} ) ; \qquad ( 1 )$$

where Tar is the target function, cᵢ is a weight factor in each field of view, R_{EE} (FOVᵢ) is the a radius encircled energy.

Therefore, the optical design method provided by the embodiment of the present application obtains the theoretical structure parameters of the optical system in S2, and competes the design of the optical system.

S3. performing a discretization on a phase of a metalens of the theoretical structure parameter and obtaining a discrete phase.

Because the optimization results in S2 are converged, the phase of the metalens obtained in S2 is continuous and is a theoretical phase in an ideal state. Due to the small size, high processing accuracy requirements and high processing difficulty of nanostructures, it is easy to cause the practical phase of metalens in use to be discrete, rather than continuous. Therefore, the optical phase of the practical nanostructure and the optical phase of the theoretical ray tracing optimization may have large differences, resulting in the possibility that the practical image performance index does not meet the design requirements. Therefore, the theoretical phase of the metalens optimized in S2 is discretized to be as close as possible to the phase of the nanostructures on the practically produced metalens.

The phase optimized of metalens in S3 is discretized by the nanostructure database. For most hybrid optical systems of metalens and refractive lens, it is difficult for the structures in the nanostructure database to fully meet the theoretical design requirements, so it is necessary to select the nanostructure such as the minimum average difference method.

In some optional embodiments, the phase of the metalens obtained by S2 is shown as formulas from (2) to (9):

$$\begin{matrix}φ ( r , λ ) = \frac{2 π}{λ} {\sum }_{i = 1}^{n} {a}_{i} \vert {r}^{i} \vert + {φ}_{0} ( λ ) ; & ( 2 ) \\ φ ( r , λ ) = \frac{2 π}{λ} {\sum }_{i = 1}^{n} {a}_{i} {r}^{2 i} + {φ}_{0} ( λ ) ; & ( 3 ) \\ φ ( r , λ ) = \frac{2 π}{λ} {\sum }_{i = 1}^{n} ( {a}_{i} {r}^{2 i} + \frac{{b}_{i}}{{r}^{2 i}} ) + {φ}_{0} ( λ ) ; & ( 4 ) \\ φ ( r , λ ) = \frac{2 π}{λ} {\sum }_{i = 1}^{n} ( \frac{{a}_{i}}{{r}^{2 i}} ) + {φ}_{0} ( λ ) ; & ( 5 ) \\ φ ( r , λ ) = \frac{2 π}{λ} {\sum }_{i = 1}^{n} ( {a}_{i} \vert {r}^{i} \vert + \frac{{b}_{i}}{\vert {r}^{i} \vert} ) + {φ}_{0} ( λ ) ; & ( 6 ) \\ φ ( x , y , λ ) = \frac{2 π}{λ} {\sum }_{j = 1}^{N} {\sum }_{i = 1}^{j} ( {a}_{ij} {x}^{i} - {y}^{j - 1} + {b}_{ij} {x}^{j - 1} {y}^{i} ) + {φ}_{0} ( λ ) ; & ( 7 ) \\ φ ( x , y , λ ) = \frac{2 π}{λ} ( f - \sqrt{{f}^{2} + {r}^{2}} ) + {φ}_{0} ( λ ) ; & ( 8 ) \\ φ ( x , y , λ ) = \frac{2 π}{λ} ( \sqrt{{f}^{2} + {r}^{2}} - f ) + {φ}_{0} ( λ ) & ( 9 )\end{matrix}$$

From formulas (2) to (9), λ is the wavelength of the light, aᵢ and bᵢ are the phase coefficients obtained by S3, (x, y) is the mirror coordinates of the metalens; r is the distance between any point of the metalens and the center of the metalens. It should be noted that the phase of the metalens can be expressed in high-degree polynomials, where formulas (2), (6) and (7) are capable of satisfying the optimization of the phase of the odd-degree polynomial without breaking its rotational symmetry, and greatly increase the optimization degree of freedom of the metalens. But formulas (3), (4), (5), (8) and (9) are only capable of satisfying the optimization of the phase of the even-degree polynomials are optimized. In addition, in formula (7), aᵢⱼ and bᵢⱼ are the asymmetric phase coefficients. It should be noted that, the positive and negative of aᵢ and bᵢ are correlated with the focal powers of the metalens, without special requirements. For example, when the metalens has a positive optical focus, in formulas (3), (4), (5), (8) and (9), a₁ or b₁ is less than zero; while in formulas (2), (6) and (7), a₂ or b₂ is less than zero. Thus, the method of designing the optical system obtains a discrete phase closer to the practical phase of the hybrid optical system of metalens and refractive lens than the theoretical structure parameters.

S4. performing an optical field propagation simulation according to the discrete phase, and obtaining an imaging performance index. Because the discrete phase isn't differentiable, it cannot be optimized by ray tracing method, but the discrete phase is optimized by the optical field propagation simulation based on the image performance index.

S5. if the image performance index meets the design requirement, obtaining a target structure parameter.
if the image performance index doesn't meet the design requirement, re-optimizing the image performance index and obtaining the target structure parameter.

Specifically, if the image performance index meets the design requirements, the structure parameter is taken as the target structure parameter; if the image performance index doesn't meet the design requirements, the method will return to S2 for re-optimization and repeat from S2 to S4, till the image performance index meets the design requirement to obtain the target structure parameter. The target structure parameter is used for debugging the optical system production.

Optical field is a four-dimensional concept of light propagation in space. It is a parametric representation of the four-dimensional optical radiation field in space containing both position and direction information. It is a set of all optical radiation functions in space. The optical field propagation simulation is used to evaluate the image performance index of the whole optical system, namely the imaging quality evaluation. The image evaluation index of the optical system includes at least the SPF (spot spread function) and the MTF (modulation transfer function).

Further, if the structure parameter obtained by S5 doesn't meet the design requirement, the method of designing the optical system provided by the present application includes:
S6. returning to S1, re-selecting the initial structure parameter and repeating S1-S5, till obtaining the target structure parameter met the design requirement.

Furthermore, the method of designing the optical system provided by the present application includes:
S7. determining a layout of the metalens, a processing drawing of the refractive lens and an assembly diagram of the optical system.
S8. producing and debugging based on the layout of the metalens, processing drawing of the refractive lens and assembly diagram of the optical system.

In one optional embodiment, “optimizing the initial structure parameter according to the ray tracing method” in S2 is based on the generalized refraction law. For the optical system provided in the embodiment of the present application, the substrate of the refractive lens and the metalens does not contain the nanostructures, and the light emitted into the substrate of a refractive lens and the metalens still satisfies the generalized refraction law as shown in formula (10):

nᵢ sin θᵢ=nᵣ sin θᵣ; (10)
where nᵢ is a refractive index of an incident medium, and nᵣ is a refractive index of a refractive medium respectively; θᵢ is an incident angle, and θᵣ is a refractive angle.

It should be noted that for the nanostructures of the metalens because the nanostructures arranged by the array on the metalens provide the mutation phases for the incident light, the light cannot satisfy formula (10) when the light passes through the nanostructure.

The nanostructure refraction formula is as follows:

$${n}_{r} sin {θ}_{r} - {n}_{i} sin {θ}_{i} = \frac{{λ}_{0}}{2 π} \frac{d φ ( r )}{dr} ; \qquad ( 11 )$$

where nᵢ is a refractive index of an incident medium, and nᵣ is a refractive index of a refractive medium respectively; θᵢ is an incident angle, and θᵣ is a refractive angle; λ is a wavelength of light in the vacuum; r is a distance between the center of a metalens and a center of any nanostructure;

$$\frac{d φ ( r )}{dr}$$

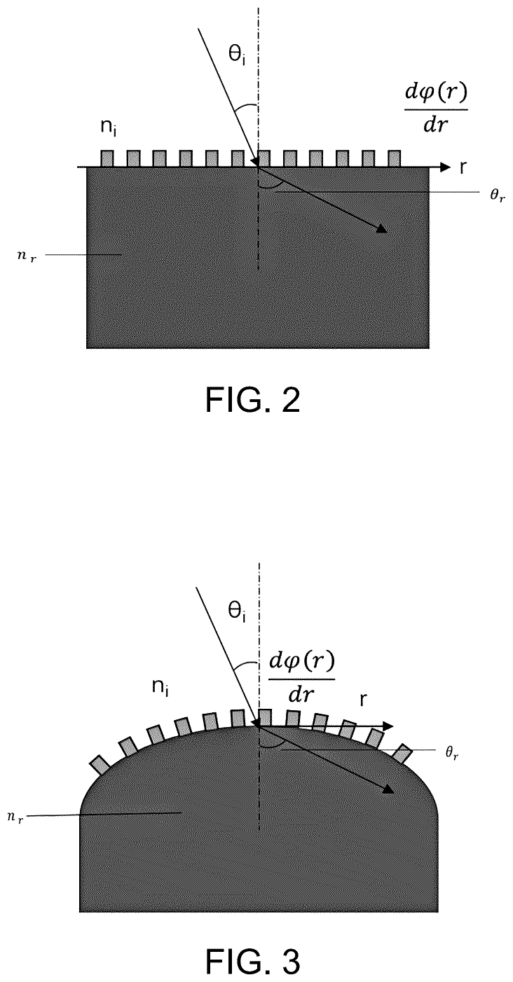

is a phase gradient along the radial direction of the metalens as shown in FIG. 2 and FIG. 3. FIG. 2 shows a phase gradient along the radial direction of the metalens provided by the embodiment of the present application. FIG. 3 shows a phase gradient along the radial direction of the metalens provided by the embodiment of the present application. The nanostructure refraction formula provided by the present application realizes the ray tracing of the nanostructure of the metalens by introducing the phase gradient along the radial direction of the metalens based on the generalized refraction law, which also overcomes the problem that the number of metalens pieces of the optical system increases the difficulty of ray tracing method.

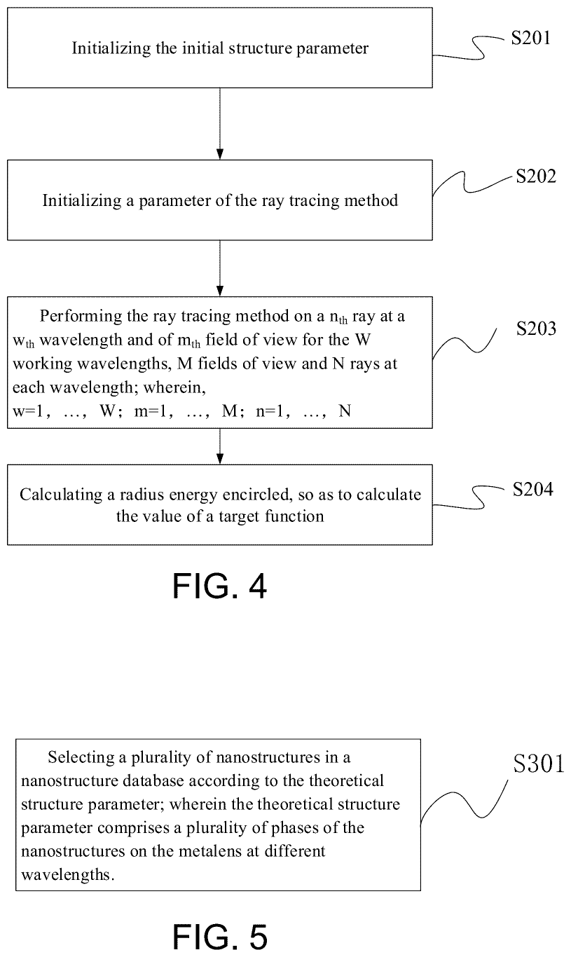

Furthermore, “optimizing the initial structure parameter based on the ray tracing method” of S2 as shown in FIG. 4 includes:
S201. initializing the initial structure parameter;
S202. initializing a parameter of the ray tracing method;

In some preferred embodiments of the embodiment of this application, ray tracing parameters are randomly generated by a computer. Using the randomly generated ray tracing parameters will have more optimized starting points, which is more conducive to obtain the global optimal solution in the optimization process of the initial structure parameters. If random ray tracing parameters are not adopted, but artificially selected ray tracing parameters are adopted, it is possible to simplify the calculation and accelerate the optimization, but it is easier to fall into the local optimization, so as to obtain the local optimal solution rather than the global optimal solution.

S203. performing the ray tracing method on a nₜₕ ray at a wₜₕ wavelength and of mₜₕ field of view for the W working wavelengths, M fields of view and N rays at each wavelength; where, w=1, . . . , W; m=1, . . . , M; n=1, . . . , N. That is, the working waveband is divided into W wavelengths (optional as equal division), such as dividing wavebands from 8-12 μm into 41 wavelengths, then 8.1 μm . . . 8.2 μm, 8.3 μm . . . 11.9 μm, 12 μm, respectively.

Specifically, the intersection coordinates of each plane of a single ray in the optical system are calculated by the generalized refraction law and the nanostructure refraction formula. If the ray reaches the image plane of the optical system, the intersection coordinate of the ray on the image plane is calculated by repeating steps from S203 to S204. If the ray doesn't reach the image plane of the optical system, the intersection coordinate of the ray on the image plane is calculated by repeating steps from S201 to S204, till w*m*n rays all reach the image plane. w*m*n means the production of w, m, n.

S204. calculating a radius of encircled energy, so as to calculate the value of a target function. Optionally, the formula (1) may be used to calculate the optimization of the target function.

$$Tar = {\sum }_{i = 1} {c}_{i} {R}_{EE} ( {FOV}_{I} ) ; \qquad ( 1 )$$

Where Tar is the target function, cᵢ is a weight factor in each field of view, R_{EE} (FOVₗ) is the radius of encircled energy.

If the optimization result diverges, the method will return to step S201 to select the initial optimization point for optimization; if the optimization result converges, the structure parameter corresponding to the value of target function is the theoretical structure parameter.

In one embodiment, in the calculation of target function of S205, the variables include a phase of metalens, a distance between the metalens and a refractive lens, a curvature of the refractive lens, and an aspherical coefficient of the refractive lens. And the target function includes a size of a spot on the focal plane of the optical system.

In an optional embodiment of the present application, in S3, as shown in FIG. 5, the discretization processing in the theoretical structure parameters includes:
S301. selecting a plurality of nanostructures in a nanostructure database according to phases corresponding to the nanostructures at different wavelengths.

Optionally, selecting the nearest nanostructure is obtained by an optimization algorithm that minimizes the weighting error, as shown in formula (12):

$$min Δ ( x , y ) = {\sum }_{i} {c}_{i} \vert {φ}_{nanostructurte} ( x , y , {λ}_{i} ) - {φ}_{j \_ lib} ( x , y , {λ}_{i} ) \vert ; \qquad ( 12 )$$

In formula (12), Δ(x, y) is a total error of the nanostructure at surface with the coordinate (x, y) of the metalens; φ_{nanostructure}(x, y, λᵢ) is a theoretical phase of the nanostructure at the wavelength of λᵢ; φ_{j_lib}(x, y, λᵢ) is a practical phase of the jₜₕ nanostructure in the nanostructure database at the wavelength of λᵢ; cᵢ is the weight coefficient of the wavelength of λᵢ.

Usually, the weight coefficient cᵢ is 1. The nanostructures with the smallest total error is set at the position of (x, y) coordinates on the metalens surface by selecting the entire nanostructure database. The method of designing the optical system obtains the nanostructure closest to the practical phase by using formula (12) to select the nanostructure. Usually, due to the rotational symmetry of the optical system, the relationship between the distance r from the center of the metalens surface to the center of any nanostructure and the coordinates (x, y) of the nanostructure on the metalens surface is as follows:

$$r = \sqrt{{x}^{2} + {y}^{2}} \qquad ( 13 )$$

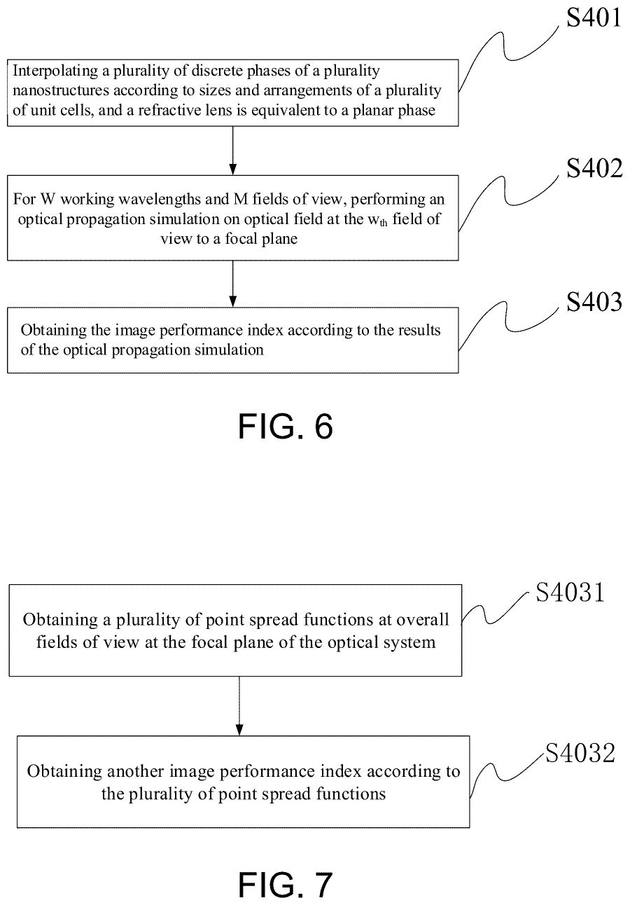

In another embodiment of the present application, S4 of performing an optical field propagation simulation according to the discrete phase, and obtaining an imaging performance index is shown in FIG. 6, which includes steps S401 to steps S403.

S401. interpolating a plurality of discrete phases of a plurality nanostructures according to sizes and arrangements of a plurality of unit cells, and a refractive lens is equivalent to a planar phase.

It should be noted that the unit cells are the smallest units of the nanostructures arrangement on the metalens. Usually, the surface of the metalens is set with unit cells in periodic arrangement, and the vertice or/and the center is set nanostructure. Preferably, the unit cell may be a dense packing pattern.

S402. for W working wavelengths and M fields of view, performing an optical propagation simulation on optical field at the wₜₕ field of view to a focal plane.

Optionally, the optical field simulation may be performed by one or more of Rayleigh-Somufi diffraction, Fresnel diffraction formulas, and Fraunhofer diffraction formulas, or by the angular spectrum corresponding to the above diffraction formulas. In the above diffraction formulas, the complexity and accuracy of the Rayleigh-Somufi diffraction formula, Fresnel diffraction formula and diffraction formula decrease successively. When the calculation force is sufficient, the Rayleigh-Sommerfi diffraction formula can be selected for simulation. Considering the calculation speed and accuracy, preferably, the optical field simulation may be performed by the Fresnel diffraction formula.

S403. obtaining the image performance index according to the results of the optical propagation simulation.

Optionally, as shown in FIG. 7, S403 specifically includes:
S4031. obtaining a plurality of point spread functions at overall fields of view at the focal plane of the optical system. In one embodiment, the visual form of the point spread function may be optical intensity diagrams on the focal plane at different fields of view.
S4032. obtaining another image performance index according to the plurality of point spread functions. For example, the other image performance index may be MTF. The calculation method of MTF is taking the modulus of the Fourier transform of the point spread function.

### Embodiment 1

In embodiment 1, an optical system is designed by using any of methods provided in the above embodiments. The design requirements of the optical system include: the working waveband is from 8 μm to 12 μm; the focal length is 2.2 mm; the F number is 1.1; the HFOV (Half Field of View) is 25°; the MTF is 301 lp/mm is greater than or equal to 0.3; the TTL (total track length) is less than or equal to 6 mm.

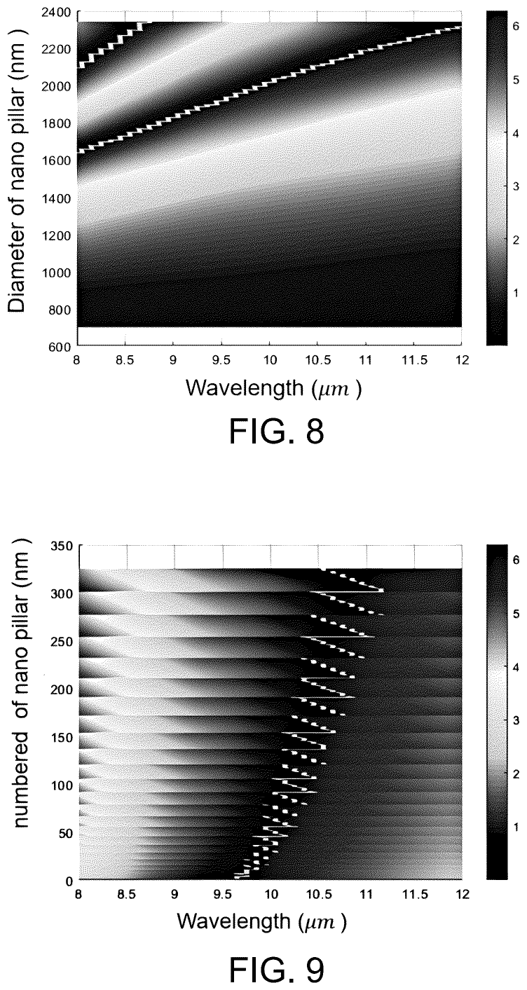

As shown in S1 of FIG. 1, the method includes selecting germanium crystals as a refractive lens and selecting silicon cylinders and silicon ring columns on sulfur series glass in the nanostructure database. The phase modulations of the silicon cylinder and silicon ring column nanostructures are shown in FIG. 8 and FIG. 9. At the same time, the initial structure of the optical system is composed of two metalenses and one refractive lens, namely 2 ML+1 P/G. The above two metalenses are ML₁ and ML₂ respectively, and the phase of the ML₁ and ML₂ are shown as formulas (9) and (10):

$$\begin{matrix}φ ( r , λ ) = \frac{2 π}{λ} ( {a}_{1} {r}^{2} + {a}_{2} {r}^{4} + {a}_{3} {r}^{6} ) ; & ( 14 ) \\ φ ( r , λ ) = \frac{2 π}{λ} ( {b}_{1} {r}^{2} + {b}_{2} {r}^{4} + {b}_{3} {r}^{6} ) ; & ( 15 )\end{matrix}$$

Where, Δ is the wavelength of light, aᵢ and bᵢ are phase coefficients of the ML₁ and ML₂ respectively. r is the distance between the center of the metalens and the center of any nanostructure. Formulas (14) and (15) are specific applications of formula (3).

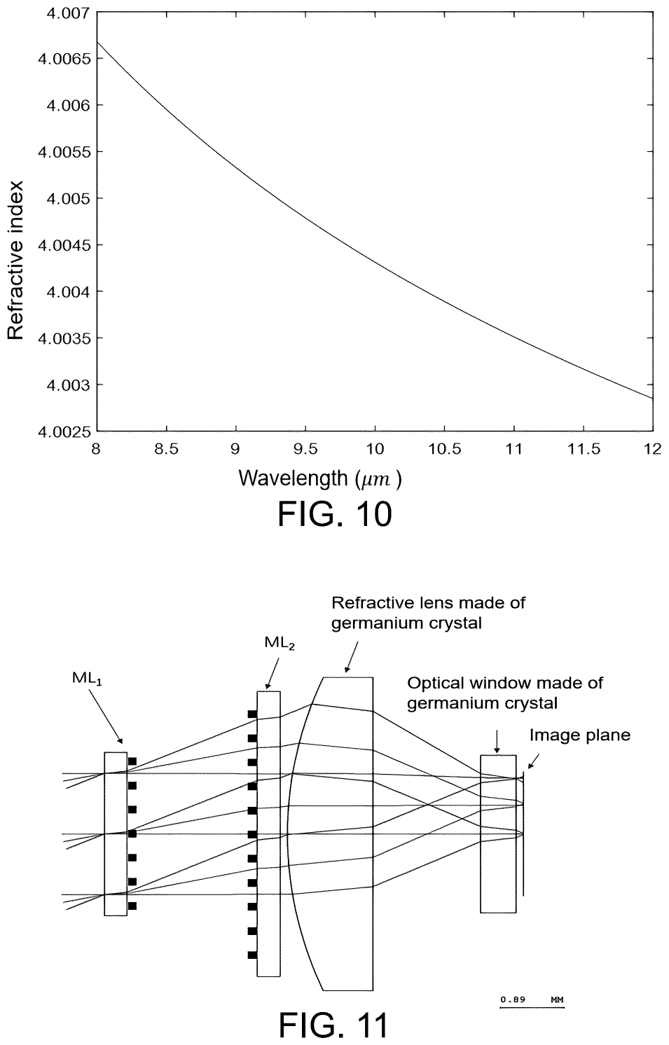

FIG. 10 shows a curve diagram of the refractive index of the germanium crystal at the wavelengths from 8-12 μm. As shown in S2 of FIG. 1, the method includes: optimizing the initial structure parameter based on the ray tracing method. Specifically, aᵢ, bᵢ, the curvature R of the refractive lens made of germanium crystal, the thickness t (t is the center thickness of the refractive lens made of germanium crystal), d₁ and d₂ (d₁ and d₂ are the distances between the two metalenses and the refractive lens) are taken as variables. And the fusion of the radius of encircled energy on the focal plane of 0 FOV, 0.5 FOV (namely 12.5° HFOV incident) and 1 FOV (namely 25° HFOV incident) as the optimization target function. Where the weight factors of all the fields of view are 1.

After optimizing the target function based on the ray tracing method, the theoretical structure parameters of the optical system are shown in FIG. 11. The nanostructures on the two metalenses ML₁ and ML₂ are set face to face, and the nanostructures are at the inside of the packaged two metalenses, which will be not easy to be broken and polluted. The TTL of the optical system is 5.8 mm, which is less than the 6 mm of the design requirement. Therefore, the theoretical structure parameter satisfies the design requirement.

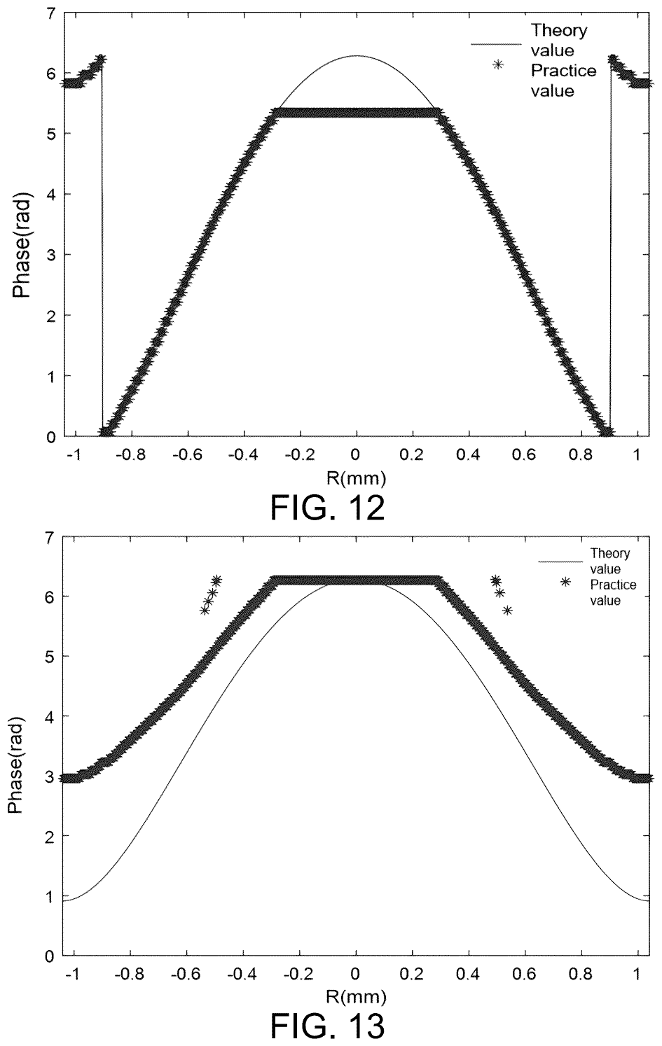

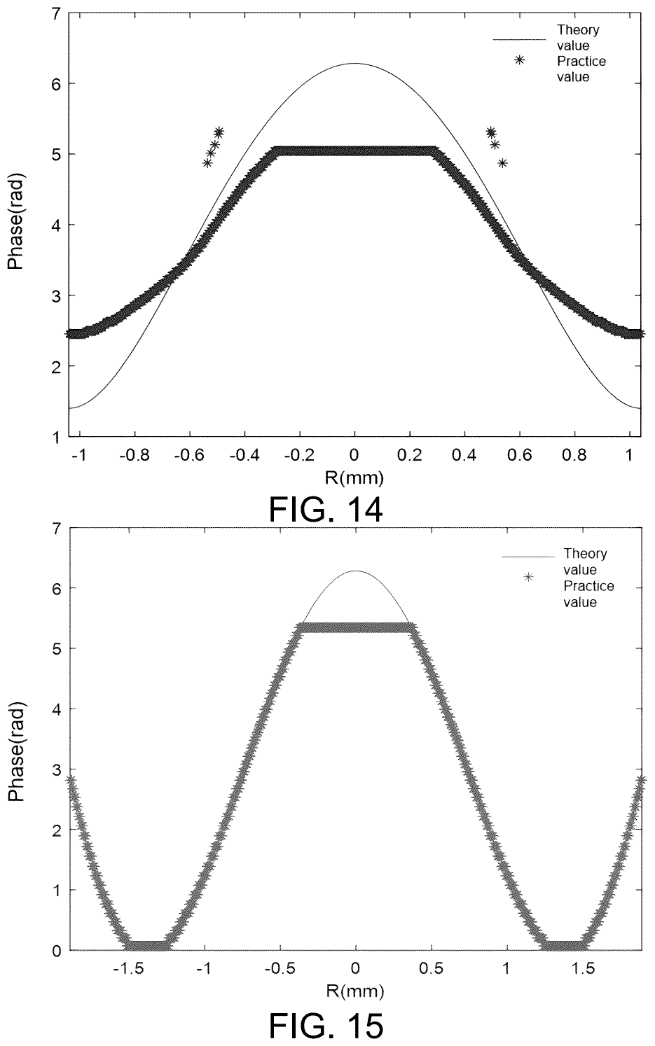

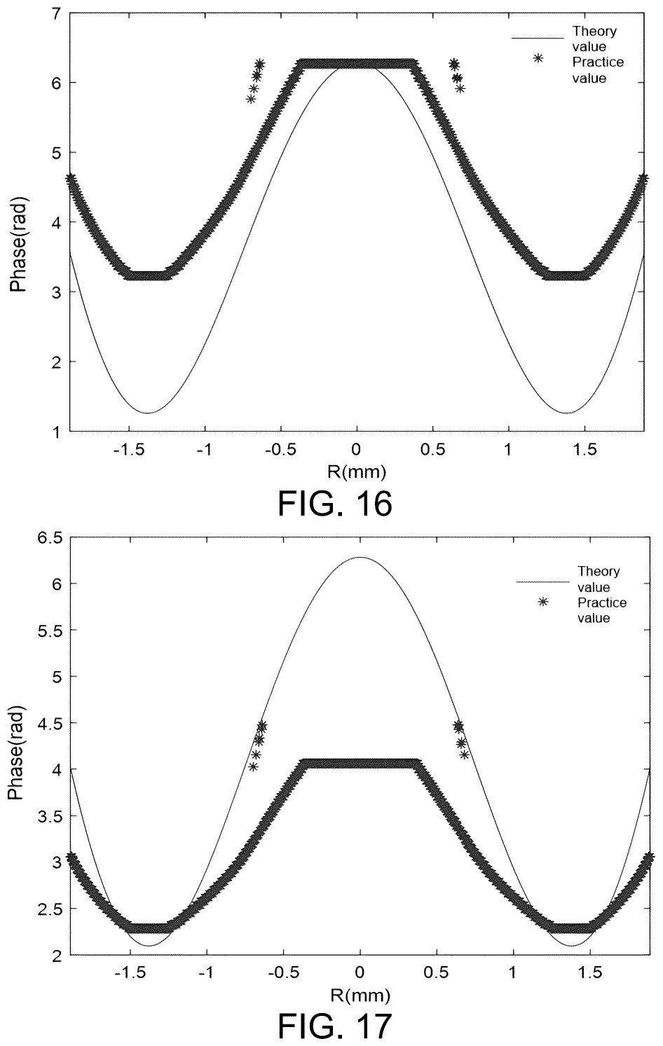

The phase coefficients at and b; of the ML₁ and ML₂ are obtained by the optimization based on the ray tracing method as shown in S3 of FIG. 1, the phase of the metalens in the theoretical structure parameters is performed discretization. In the nano cylinder and ring column database, the discrete effects are shown in FIG. 12 to FIG. 17. Referring to FIG. 16 and FIG. 17, the maximum value of the theoretical phase variation between the phase of discrete coordinates and the phase obtained by ray tracing method is less than 2 rad.

As shown in S4 and S5, the next step includes: further optimizing the optical system based on the discrete phase, and obtaining the target structure parameter.

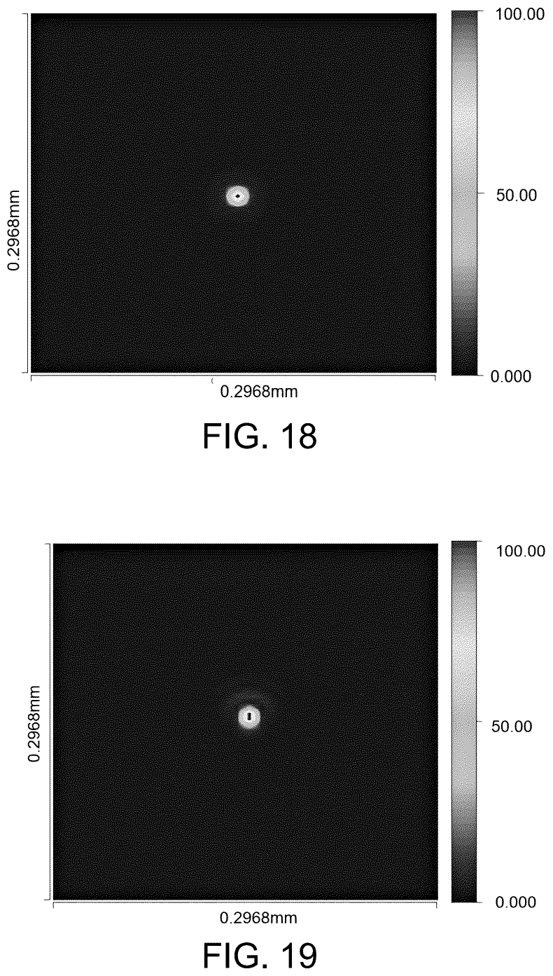

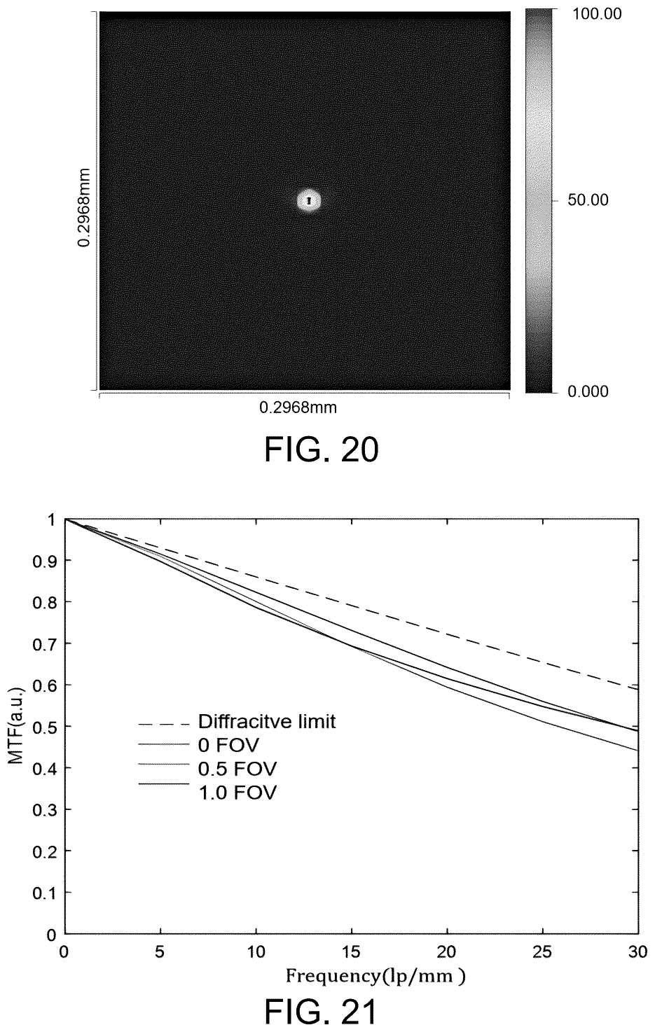

As shown in S4 of FIG. 1, S4 specifically includes performing the optical field simulation on the data of discrete phases and planner refractive lens made of germanium crystal and obtaining the image performance index. For example, the light intensity diagrams on the focal plane of 0 FOV, 0.5 FOV and 1 FOV, namely the spot diagrams are shown from FIG. 18 to FIG. 20. In one embodiment, the next calculation may be taking the modulus of the Fourier transform of the point spread function. As shown in FIG. 21, the MTF at all the FOV is greater than 0.3 at the cut-off frequency of 30 lp/mm, which satisfies the design requirement.

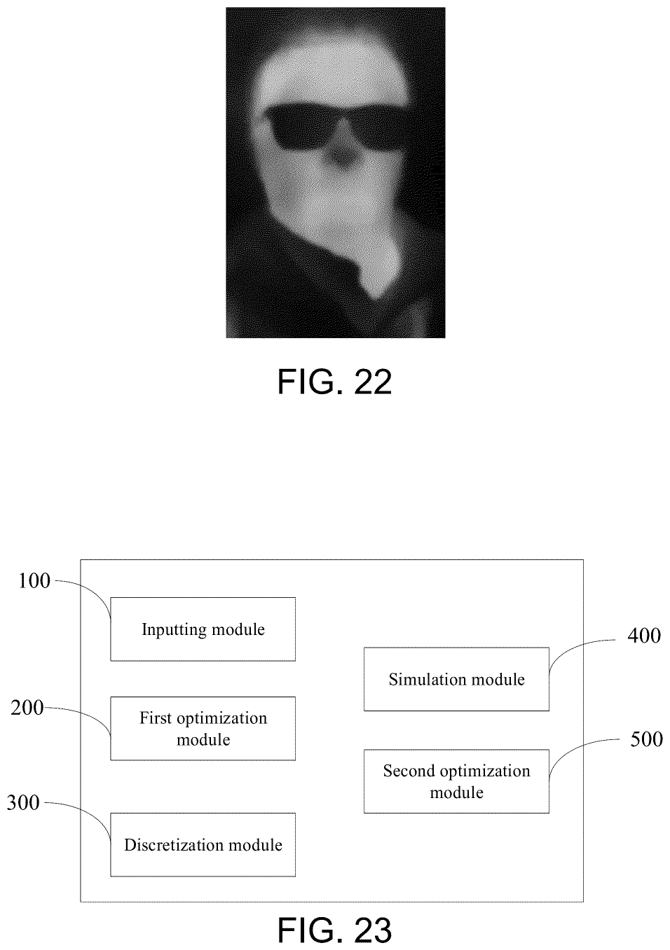

The target structure parameter obtained according to the S5 may follow from S6-S8 to process, so as to obtain the optical system that meets the design requirements. The practical image effect diagram is shown in FIG. 22. In addition, performing a simulation on the optical system at different temperatures (−40° C.˜60° C.), it is found that the optical system is insensitive to temperature changes.

In summary, the method of designing the optical system optimizes the initial structure parameter based on the ray tracing method, in particular to optimize the metalens by the nanostructure refraction law, so as to obtain the theoretical structure parameter. And the theoretical structure parameter is discretization, so as to obtain the discrete phase to make the phase of the nanostructures of the metalens in the optical system closer to the phase of the metalens in practical production. Finally, the problem of the ray tracing method can't be applied to the discrete phase is overcome by using the optical propagation simulation, and the target structure parameter for production is obtained by the optimization of the distance phase.

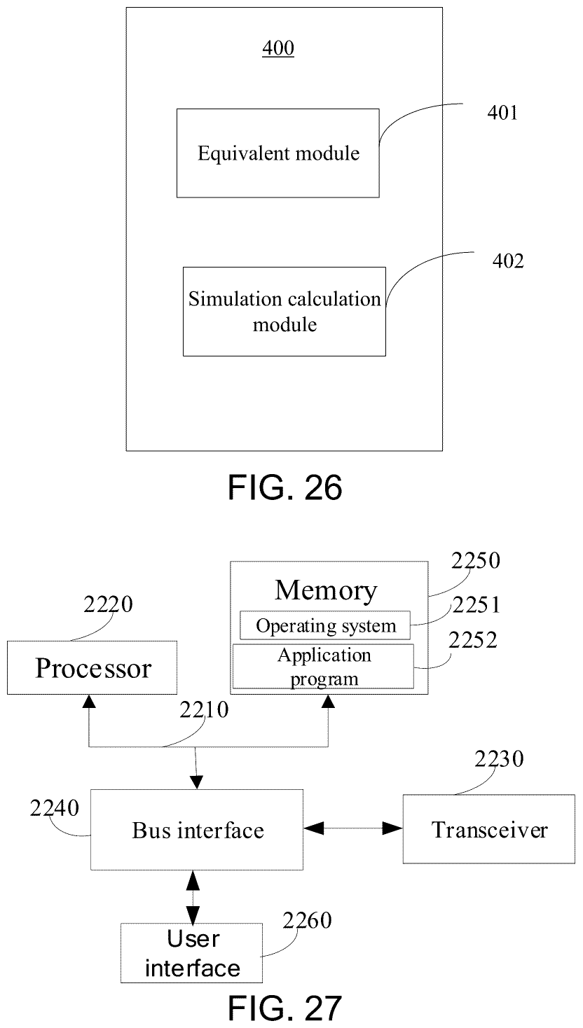

From FIG. 1 to FIG. 22, the method of designing the optical system provided in this application embodiment is described in detail above, which can also be realized by a corresponding device, and the device of designing the optical system is provided in FIG. 23 to FIG. 26.

FIG. 23 shows a schematic diagram of the device of designing an optical system provided by the embodiment of the present application. As shown in FIG. 23, the device includes:
an inputting module 100, the inputting module is configured to input an initial structure parameter of the optical system;
a first optimization module 200, the optimization module is configured to perform optimization on the initial structure parameter according to the ray tracing method theory, so as to obtain a theoretical structure parameter;
a discretization module 300, the discretization module is configured to perform the discretization on a phase of a metalens of the theoretical structure parameter, so as to obtain a discrete phase;
a simulation module 400, the simulation module is configured to perform an optical field propagation simulation according to the discrete phase, so as to obtain an imaging performance index;
a second optimization module 500, the second optimization module is configured to obtain a target structure parameter, if the image performance index meets the design requirement; and the second optimization module is configured to re-optimize the image performance index and obtain the target structure parameter, if the image performance index doesn't meet the design requirement.

Therefore, according to the device of designing an optical system, the inputting module is configured to input an initial structure parameter of the optical system; the optimization module is configured to perform optimization on the initial structure parameter according to the ray tracing method theory, so as to obtain a theoretical structure parameter; the discretization module is configured to perform the discretization on a phase of a metalens of the theoretical structure parameter, so as to obtain a discrete phase; the simulation module is configured to perform an optical field propagation simulation according to the discrete phase, so as to obtain an imaging performance index. Since the device provided in the embodiment of the present application obtains the target structure parameters based on the discrete phase closer to the phase in practical production, the optical system designed by the device is closer to the practical production.

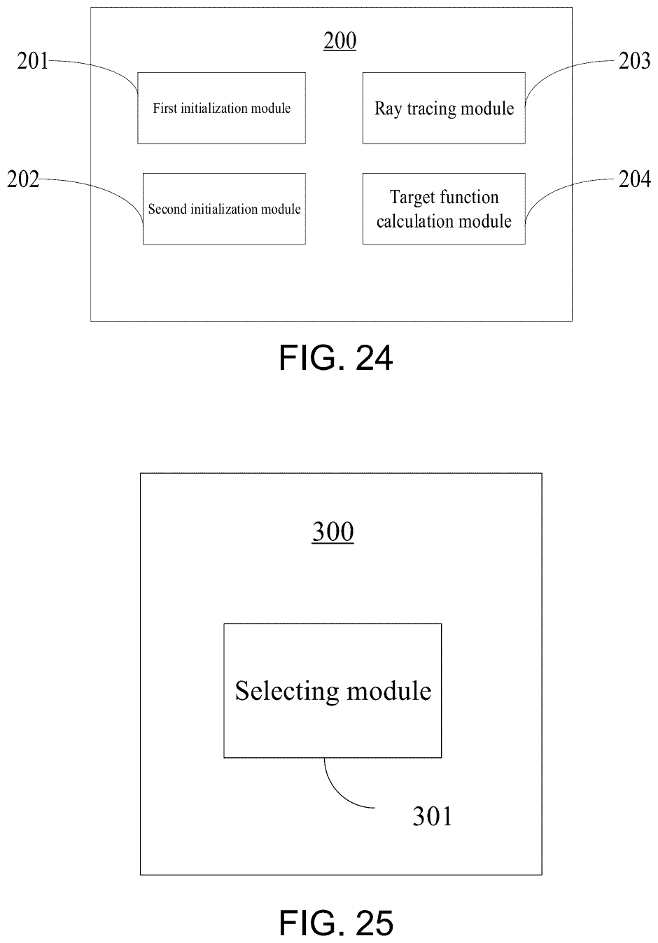

In the embodiment of the present application, optionally, as shown in FIG. 24, the first optimization module includes:
a first initialization module, the first initialization module is configured to initialize the initial structure parameter;
a second initialization module, the second initialization module is configured to initialize a ray tracing method parameter;
a ray tracing module, performing the ray tracing method on a nₜₕ ray at a wₜₕ wavelength, mₜₕ field of view for the W working wavelengths, M fields of view and N rays at each wavelength; where, w=1, . . . , W; m=1, . . . , M; n=1, . . . , N;
a target function calculation module, the target function calculation module is configured to calculate a radius of encircled energy, so as to calculate the value of a target function.

In the embodiment of the present application, as optional, as shown in FIG. 25, the discrete module 300 provided by the embodiment of the present application includes:
a selecting module, the selection module is configured to select a plurality of nanostructures in a nanostructure database according to phases corresponding to the nanostructures at different wavelengths.

Furthermore, the embodiment of this application also provides an electronic device including a bus, a transceiver, a memory, a processor and a computer program stored on the memory and run on the processor implements each process of the embodiment of the optical system design method, and can achieve the same technical effect, so as to avoid repetition.

Specifically, the embodiment of this disclosure also provides an electronic device including a bus 2210, a processor 2220, a transceiver 2230, a bus interface 2240, a memory 2250, and a user interface 2260.

In the embodiment of the present disclosure, the electronic device also includes a computer program stored on the memory 2250 and the computer program can be operated on the processor 2220. The computer program implements the following steps when the computer program is executed by the processor 2220:
S1. determining an initial structure parameter of the optical system according to a design requirement;
S2. optimizing the initial structure parameter according to the ray tracing method, and obtaining a theoretical structure parameter;
S3. performing a discretization on a phase of a metalens of the theoretical structure parameter and obtaining a discrete phase;
S4. performing an optical field propagation simulation according to the discrete phase, and obtaining an imaging performance index;
S5. if the image performance index meets the design requirement, obtaining a target structure parameter; if the image performance index doesn't meet the design requirement, re-optimizing the image performance index and obtaining the target structure parameter.

Optionally, the computer program implements the following steps when the computer program is executed by the processor 2220:
S6. returning to S1, re-selecting the initial structure parameter and repeating S1-S5, till obtaining the target structure parameter met the design requirement.
S7. determining a layout of the metalens, a processing drawing of the refractive lens and an assembly diagram of the optical system.
S8. producing and debugging based on the layout of the metalens, processing drawing of the refractive lens and assembly diagram of the optical system.

Optionally, the computer program implements the following S2 when the computer program is executed by the processor 2220:
S201. initializing the initial structure parameter;
S202. initializing a parameter of the ray tracing method;
S203. performing the ray tracing method on a nₜₕ ray at a wₜₕ wavelength and of mₜₕ field of view for the W working wavelengths, M fields of view and N rays at each wavelength;
where, w=1, . . . , W; m=1, . . . , M; n=1, . . . , N;
S204. calculating a radius of encircled energy, so as to calculate the value of a target function.

Optionally, the computer program implements the following S3 when the computer program is executed by the processor 2220:
S301. selecting a plurality of nanostructures in a nanostructure database according to the theoretical structure parameter;
where the theoretical structure parameter includes a plurality of phases of the nanostructures on the metalens at different wavelengths.

Optionally, the computer program implements the following S4 when the computer program is executed by the processor 2220:
S401. interpolating a plurality of discrete phases of a plurality nanostructures according to sizes and arrangements of a plurality of unit cells, and a refractive lens is equivalent to a planar phase;
S402. for W working wavelengths and M fields of view, performing an optical propagation simulation on optical field at the wₜₕ field of view to a focal plane;
S403. obtaining the image performance index according to the results of the optical propagation simulation.

Optionally, the computer program implements the following S403 when the computer program is executed by the processor 2220:
S4031. obtaining a plurality of point spread functions at overall fields of view at the focal plane of the optical system;
S4032. obtaining another image performance index according to the plurality of point spread functions.

In the present application, the transceiver 2230 is used to receive or transit the data by the control of the processor 2220.

In the embodiment of the present disclosure, a bus framework (represented by the bus 2210), the bus 2210 any number of interconnected buses and bridges. The bus 2210 is configured to connect various circuits of one or more processors represented by the processor 2220 and a memory represented by the memory 2250.

The bus 2210 represents one or more of any one of a plurality of types of bus structures. The bus 2210 includes a memory bus and a local bus of any structure in a memory controller, a peripheral bus, an Accelerate Graphical Port (AGP), a processor or an architecture using various buses. For the purpose of illustration rather than limitation, the architecture includes an Industry Standard Architecture (ISA) bus, a Micro Channel Architecture (MCA) bus, an Enhanced ISA (EISA) bus, a Video Electronics Standards Association (VESA) bus, a Peripheral Component Interconnect (PCI) bus.

The processor 2220 may be an integrated circuit chip with signal processing capabilities. During the implementation processes, respective steps of the method described in the above embodiments may be completed by instructions in the form of integrated logic circuits in hardware or software in the processor. The processor may be a general-purpose processor, a Central Processing Unit (CPU), a Network Processor (NP), a Digital Signal Processor (DSP), an Application Specific Integrated Circuit (ASIC), a Field Programmable Gate Array (FPGA), a Complex Programmable Logic Device (CPLD), a Programmable Logic Array (PLA), a Microcontroller Unit (MCU) or other equipment such as a programmable logic device, a discrete gate, a transistor logic device, a discrete hardware component, which are capable of implementing or executing the method, respective steps and logical block diagrams disclosed in the present embodiment. For example, the processor may be a single-core processor or a multi-core processor. The processor may be integrated into a single chip or located on multiple different chips.

The processor 2220 may be a microprocessor or any conventional processor. The steps of the method disclosed in the present embodiment may be directly executed by a hardware decoding processor, or may be executed by a combination of a hardware module and a software module in a decoding processor. The software module may be provided in a readable storage media including Random Access Memory (RAM), Flash Memory (Flash Memory), Read-Only Memory (ROM), Programmable Read-Only Memory (PROM), Erasable PROM (EPROM) and a register, which are known in the art. The readable storage medium is located in the memory. The processor reads information in the memory and completes the steps of the method in combination with the hardware of the processor.

The bus 2210 may also realize the circuit connection of other devices such as peripheral equipment, a voltage regulator or power management circuit. The bus interface 2240 provides an interface between the bus 2210 and the transceiver 2230, which are known in the art. The general knowledge will not be described herein.

The transceiver 2230 may be an element or may be multiple elements, such as multiple receivers and multiple transmitters. The transceiver 2230 is configured to serve as a unit for communicating with various other devices over a transmission medium. For example, the transceiver 2230 receives external data from other devices, and the transceiver 2230 is used to send the processed data by the processor 2220 to other devices. Depending on the type of the computer system, a user interface 2260 may also be provided. The user interface 2260 may be a touch screen, a physical keyboard, a monitor, a mouse, a speaker, a microphone, a trackball, a joystick or a stylus.

It should be understood that in the present embodiment, the memory 2250 may further include memories remotely located relative to the processor 2220. The memories may be connected to a server through a network. One or more parts of the network may be an ad hoc network, an intranet, an extranet, a virtual private network (VPN), a local area network (LAN), a wireless local area network (WLAN), a wide area network (WAN), a wireless wide area network (WWAN), a metropolitan area network (MAN), Internet, a public switched telephone network (PSTN), a plain old telephone service (POTS) network, a cellular telephone network, a wireless network, a wireless fidelity (Wi-Fi) network or a combination thereof. The combination includes at least two kinds of networks listed herein. For example, the cellular telephone network and the wireless network may be a Global System for Mobile Communications (GSM), Code Division Multiple Access (CDMA), Worldwide Interoperability for Microwave Access (WiMAX), General Packet Radio Service (GPRS), a Broadband CDMA (WCDMA) system, a Long Term Evolution (LTE) system, an LTE Frequency Division Duplex (FDD) system, an LTE Time Division Duplex (TDD) system, a Long Term Evolution Advanced (LTE-A) system, a Universal Mobile Telecommunications (UMTS) system, an Enhanced Mobile Broadband (eMBB) system, a massive Machine Type of Communication (mMTC) system, an Ultra Reliable Low Latency Communications (uRLLC) system, etc.

It should be understood that the memory 2250 in the present embodiment may be a volatile memory, a non-volatile memory, or a combination thereof. Where, the non-volatile memory may be a Read-Only Memory (ROM), a Programmable ROM (PROM), and an Erasable PROM (EPROM), an Electrically EPROM (EEPROM) or a Flash Memory.

The Volatile memory may be a Random Access Memory (RAM), which is used as an external cache. The RAM may be of various types. For the purpose of illustration but not limitation, the RAM may be a Static RAM (SRAM), a Dynamic RAM (DRAM), a Synchronous DRAM (SDRAM), a Double Data Rate SDRAM (DDRSDRAM), an Enhanced SDRAM (ESDRAM), a synchronous link DRAM (SLDRAM) or a Direct Rambus RAM (DRRAM). The memory 2250 described in the present embodiment may be any of memories listed herein or may be any of other appropriate memories, and the present embodiment is not limited thereto.

In the embodiment of the present disclosure, the memory 2250 stores the following elements of an operating system 2251 and an application program 2252, including an executable module and a data structure, a subset of the operating system 2251 and the application program 2252 or an extended set of the operating system 2251 and the application program 2252.

Specifically, the operating system 2251 includes a variety of system programs including a framework layer, a core library layer and a driver layer, which are used to implement various basic services and process hardware-based tasks. The application program 2252 includes a variety of application programs including a Media Player and a Browser, which are used to implement various application services. Programs of implementing the method of the embodiments of the present disclosure may be included in the application program 2252. The application program 2252 includes applets, objects, components, logic, data structures, and other computer-executable instructions that perform specific tasks or implement specific abstract data types.

Further, the embodiment of this application also provides a computer readable storage medium on which a computer program in the computer that achieves the same technical effect, to avoid repetition.

Computer-readable storage media include permanent and non-permanent, removable and non-removable media, tangible devices that can retain and store instructions for instruction execution used by the device. Computer readable storage media include electronic storage, magnetic storage, optical storage, electromagnetic storage, semiconductor storage and any of the suitable combinations described above. Computer readable storage media include: phase change memory (PRAM), static random access memory (SRAM), dynamic random access memory (DRAM), other types of random access memory (RAM), read only memory (ROM), non-volatile random access memory (NVRAM), electric erasable programmable read only memory (EEPROM), flash memory or other memory technology, optical disc read only memory (CD-ROM), digital multi-function CD (DVD) or other optical storage, magnetic cartridge tape storage, tape disk storage or other magnetic storage devices, notes Memory sticks, a mechanical coding device (e.g., a punch card or bulge structure in a groove on which the instruction is recorded), or any other non-transmission medium, may be used to store information that can be accessed by the computing device. As defined in the embodiment of the present application, the computer-readable storage medium does not include a temporary signal itself, such as radio waves or other freely propagating electromagnetic waves, electromagnetic waves transmitted through a waveguide or other transmission medium (e.g. optical pulses through a fiber optic cable) or an electrical signal transmitted through a wire.

In the several embodiments provided in the present application, it should be understood that the disclosed devices, electronic devices, and methods may be realized in other ways. For example, the device embodiment described above is merely schematic, for example, the division of the module or unit is only a logical function division, which may be practically implemented, such as a plurality of units or components can be combined or integrated into another system, or some features can be ignored or not executed. Further, the coupling or direct coupling or communication connection between each other shown or discussed may be indirect coupling or communication connection through some interfaces, devices or units, or may be electrical, mechanical or other form connection.

The cells described as the separation part may or may not be physically separate, and the components displayed as cells may or may not be physical cells, which may be located in a location or distributed to a plurality of network cells. Some or all of the units may be selected according to the practical needs to solve the problems to be solved in the embodiment of the present application.

Also, each functional unit in the various embodiments of the present application may be integrated in one processing unit, each unit may be physically present alone, or two or more units may be integrated in one unit. The above integrated units can be implemented using either hardware or software function units.

The integrated unit may be stored in a computer-readable storage medium if implemented as a software functional unit and sold or used as a separate product. Based on this understanding, the technical solution of the present application embodiment is essentially or a contribution to the prior art, or may be embodied in the form of a software product stored in a storage medium including a number of instructions to make a computer device (including a personal computer, server, data center, or other network device) perform all or part of the steps described in each of the respective embodiments of this application. The above storage media includes various media, as listed above, which can store the program code.

The above is only a specific embodiment of the embodiment of this application, but the scope of protection of the embodiment of this application is not limited to this, any person familiar with the scope of the change or substitution, should be covered within the protection scope of the embodiment of this application. Therefore, the scope of the embodiment of this application shall depend to the scope of the claim.

What is claimed is:

1. A method of designing an optical system, wherein the method comprises:
S1: determining an initial structure parameter of the optical system according to a design requirement;
S2: optimizing the initial structure parameter according to the ray tracing method, and obtaining a theoretical structure parameter;
S3: performing a discretization on a phase of a metalens of the theoretical structure parameter and obtaining a discrete phase;
S4: performing an optical field propagation simulation according to the discrete phase, and obtaining an imaging performance index;
S5: if the image performance index meets the design requirement, obtaining a target structure parameter;
if the image performance index doesn't meet the design requirement, re-optimizing the image performance index and obtaining the target structure parameter.

2. The method according to claim 1, wherein the S2 further comprises:
S201: initializing the initial structure parameter;
S202: initializing a parameter of the ray tracing method;
S203: performing the ray tracing method on a nₜₕ ray at a wₜₕ wavelength and of mₜₕ field of view for the W working wavelengths, M fields of view and N rays at each wavelength;
wherein, w=1, . . . , W; m=1, . . . , M; n=1, . . . , N;
S204: calculating a radius of encircled energy, so as to calculate the value of a target function.

3. The method according to claim 1, wherein “optimizing to the initial structure parameter according to the ray tracing method” comprises:
minimizing a value of a target function;
wherein the target function satisfies:
$$Tar = {\sum }_{i = 1} {c}_{i} {R}_{EE} ( {FOV}_{I} ) ;$$
wherein Tar is the target function, cᵢ is a weight factor in each field of view, R_{EE} (FOVᵢ) is the radius of encircled energy.

4. The method according to claim 1, wherein S3 comprises:
S301: selecting a plurality of nanostructures in a nanostructure database according to the theoretical structure parameter;
wherein the theoretical structure parameter comprises a plurality of phases of the nanostructures on the metalens at different wavelengths.

5. The method according to claim 1, wherein S3 comprises:
S401: interpolating a plurality of discrete phases of a plurality nanostructures according to sizes and arrangements of a plurality of unit cells, and a refractive lens is equivalent to a planar phase;
S402: for W working wavelengths and M fields of view, performing an optical propagation simulation on optical field at the wₜₕ field of view to a focal plane;
S403: obtaining the image performance index according to the results of the optical propagation simulation.

6. The method according to claim 5, wherein S403 comprises:
S4031: obtaining a plurality of point spread functions at overall fields of view at the focal plane of the optical system;
S4032: obtaining other image performance indexes according to the plurality of point spread functions.

7. The method according to claim 1, wherein S5 comprises:
when the image performance index doesn't meet the design requirement, repeating steps from the S2 to S4, till obtaining the image performance index met the design requirement.

8. The method according to claim 1, wherein “optimizing the initial structure parameter” of S2 is based on the generalized refraction law.

9. The method according to claim 8, wherein the generalized refraction law comprises: the refraction law and the nanostructure refraction formula;
the refraction law is as follows:
$${n}_{i} sin {θ}_{i} = {n}_{r} sin {θ}_{r}$$
wherein, nᵢ is a refractive index of an incident medium, and nᵣ is a refractive index of a refractive medium respectively; θᵢ is an incident angle, and θᵣ is a refractive angle;
wherein the nanostructure refraction formula is as follows:
$${n}_{r} sin {θ}_{r} - {n}_{i} sin {θ}_{i} = \frac{{λ}_{0}}{2 π} \frac{d φ ( r )}{dr} ;$$
wherein nᵢ is a refractive index of an incident medium, and nᵣ is a refractive index of a refractive medium respectively; θᵢ is an incident angle, and θᵣ is a refractive angle; λ is a wavelength of light in the vacuum; r is a distance between the center of a metalens and a center of any nanostructure;
$$\frac{d φ ( r )}{dr}$$
is a phase gradient along the radial direction of the metalens.

10. The method according to claim 4, wherein S301 comprises:
selecting a nanostructure with a phase that is closest to a practical phase by an optimization algorithm.

11. The method according to claim 1, wherein the method further comprises:
S6; returning to S1 to re-select the initial structure parameters and repeat from S1 to S5 until the target structure parameter meets the design requirement.

12. The method according to claim 1, wherein the design requirements comprise: a working waveband, a field of view, a focal length, a transmittance, a modulation transfer function and a total track length.

13. The method according to claim 1, wherein the initial structure parameter comprises a material, a number of a metalens and refractive lens, a phase of the metalens, a distance between the metalens and the refractive lens; a curvature of the refractive lens and an aspherical coefficient of the refractive lens.

14. The method according to claim 2, wherein the calculation of the target function of the S204, the variables comprise: a phase of metalens, a distance between the metalens and a refractive lens, a curvature of the refractive lens, and an aspherical coefficient of the refractive lens.

15. The method according to claim 2, wherein the calculation of the target function of the S204, the target function comprises a size of a spot on the focal plane of the optical system.

16. A device of designing an optical system, wherein the device is applied to the method of designing the optical system claimed as claim 1, and the device comprises:
an inputting module, the inputting module is configured to input an initial structure parameter of the optical system;
a first optimization module, the optimization module is configured to perform optimization on the initial structure parameter according to the ray tracing method theory, so as to obtain a theoretical structure parameter;
a discretization module, the discretization module is configured to perform the discretization on a phase of a metalens of the theoretical structure parameter, so as to obtain a discrete phase;
a simulation module, the simulation module is configured to perform an optical field propagation simulation according to the discrete phase, so as to obtain an imaging performance index;
a second optimization module, the second optimization module is configured to obtain a target structure parameter, if the image performance index meets the design requirement;
and the second optimization module is configured to re-optimize the image performance index and obtain the target structure parameter, if the image performance index doesn't meet the design requirement.

17. The device according to claim 16, wherein the first optimization module comprises:
a first initialization module, the first initialization module is configured to initialize the initial structure parameter;
a second initialization module, the second initialization module is configured to initialize a ray tracing method parameter;
a ray tracing module, performing the ray tracing method on a nₜₕ ray at a wₜₕ wavelength, mₜₕ field of view for the W working wavelengths, M fields of view and N rays at each wavelength;
wherein, w=1, . . . , W; m=1, . . . , M; n=1, . . . , N;
a target function calculation module, the target function calculation module is configured to calculate a radius of encircled energy, so as to calculate the value of a target function.

18. The device according to claim 16, wherein the discretization module comprises:
a selecting module, the selection module is configured to select a plurality of nanostructures in a nanostructure database according to phases corresponding to the nanostructures at different wavelengths.

19. The device according to claim 16, wherein the simulation module comprises:
an equivalent module, the equivalent module is configured to interpolate a plurality of discrete phases of a plurality of nanostructures according to sizes and arrangements of a plurality of unit cells, and be equivalent to a refractive lens as a planar phase;
a simulation calculation module, the simulation calculation module is configured to perform an optical propagation simulation on the wₜₕ field of view as the optical field propagating to a focal plane of the optical system for W working wavelengths and M fields of view, and obtain the image performance index according to the results of the simulation.

20. An electronic device, comprising: a bus, a processor, a transceiver, a bus interface, a memory, a user interface and a computer program;
wherein the computer program is stored in the memory and executable on the processor; the transceiver, the memory and the processor are connected through the bus; the computer program is executed by the processor, so as to implement the method of claim 1.
